(19) United States
(12) Patent Application Publication
(10) Pub. No.: US 2010/0045625 A1
(43) Pub. Date: Feb. 25, 2010

(54) TOUCH PANEL AND SYSTEM FOR DISPLAYING IMAGES UTILIZING THE SAME

(75) Inventors: Kai-Chieh Yang, Niaosong Township (TW); Wei-Cheng Lin, Kaohsiung City (TW); Ting-Kuo Chang, Hsinchu City (TW)

Correspondence Address: LIU & LIU, 444 S. FLOWER STREET, SUITE 1750, LOS ANGELES, CA, 90071, US

(73) Assignee: TPO DISPLAYS CORP., Chu-Nan (TW)

(21) Appl. No.: 12/543,661

(22) Filed: Aug. 19, 2009

Related U.S. Application Data
(60) Provisional application No. 61/189,777, filed on Aug. 21, 2008.

(30) Foreign Application Priority Data
Mar. 31, 2009 (TW) 098110612

(51) Int. Cl. G06F 3/041

(52) U.S. Cl. 345/173

(57) ABSTRACT

An embodiment of the invention provides a touch panel, which includes a substrate, a lower conductive layer overlaying the substrate, an insulating layer overlaying the lower conductive layer, and an upper conductive layer overlaying the insulating layer. The lower conductive layer includes a plurality of first conductive patterns including a plurality of first electrodes and a plurality of first dummy patterns, wherein the first dummy patterns are electrically insulated from the first conductive patterns. The upper conductive layer includes a plurality of second conductive patterns including a plurality of second electrodes respectively overlapping the first dummy patterns and a plurality of second dummy patterns, wherein the second dummy patterns are electrically insulated from the second conductive patterns and respectively overlapping the first electrodes.

### CROSS REFERENCE TO RELATED APPLICATIONS

This Application claims the benefit of U.S. Provisional Application No. 61/189,777, filed on Aug. 21, 2008, the entirety of which is incorporated by reference herein. This Application claims priority of Taiwan Patent Application No. 98110612, filed on Mar. 31. 2009, the entirety of which is incorporated by reference herein.

### BACKGROUND

1. Technical Field

The disclosure relates to a touch panel and a system for displaying images utilizing the same, and in particular relates to a touch panel having dummy patterns.

2. Description of the Related Art

A capacitive touch panel is one type of commonly used touch panel. Instructions are input into the capacitive touch panel through detecting changes of capacitance when touching the panel with a conductor. Relatively, the capacitive touch panel has good touch sensitivity and structural stability. However, different reflection rates occur due to the height differences between the sensing electrodes of the capacitive touch panel. In addition, the spacings between the sensing electrodes of the capacitive touch panel are wide. Thus, display quality of the capacitive touch panel is poor.

Therefore, a touch panel having good display quality is desired.

### SUMMARY

In accordance with an embodiment of the invention, a touch panel is provided, which includes: a substrate; a lower conductive layer overlaying the substrate; an insulating layer overlaying the lower conductive layer; and an upper conductive layer overlaying the insulating layer. The lower conductive layer includes a plurality of first conductive patterns including a plurality of first electrodes and includes a plurality of first dummy patterns electrically insulated from the first conductive patterns. The upper conductive layer includes a plurality of second conductive patterns including a plurality of second electrodes respectively overlapping the first dummy patterns and includes a plurality of second dummy patterns electrically insulated from the second conductive patterns and respectively overlapping the first electrodes.

In accordance with another embodiment of the invention, a system for displaying images is provided, which includes a display device including the touch panel of the invention.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1A-1D are layouts of a lower conductive layer and an upper conductive layer, a top view, and a cross-sectional view showing a touch panel in accordance with an embodiment of the present invention;

FIGS. 2A-2B are a top view and a cross-sectional view showing a touch panel in accordance with another embodiment of the present invention:

FIGS. 3A-3B are a top view and a cross-sectional view showing a touch panel having staggered stacked layers in accordance with another embodiment of the present invention;

FIGS. 4A-4B are a top view and a cross-sectional view showing a touch panel in accordance with another embodiment of the present invention; and

FIG. 5 is a schematic diagram showing a system for displaying images in accordance with an embodiment of the present invention.

### DETAILED DESCRIPTION

According to embodiments of the present invention, floating dummy patterns are formed in a touch panel. By controlling the positions, sizes, and types of the dummy patterns, light paths may be adjusted, further improving display quality of the touch panel.

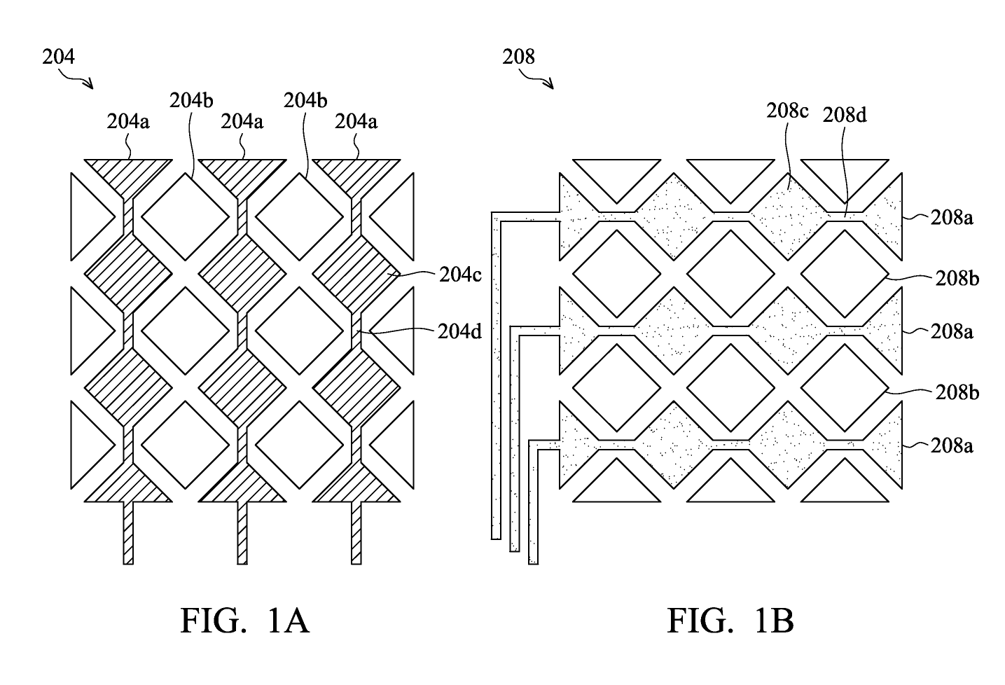

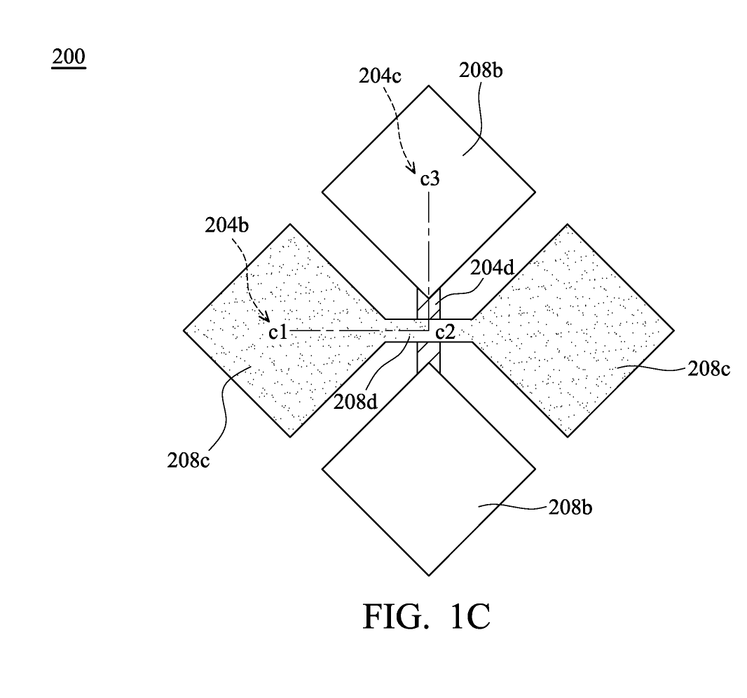

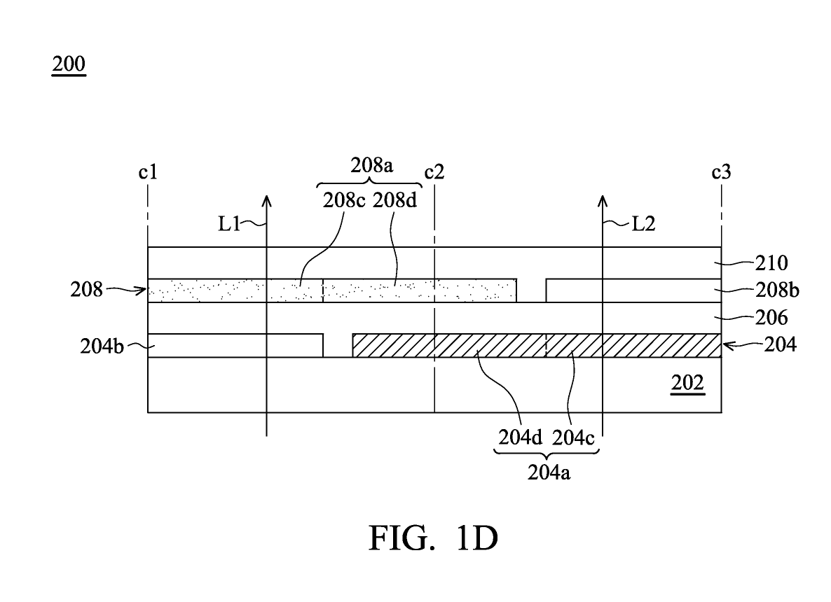

According to an embodiment of the invention, a touch panel comprises a lower conductive layer, an upper conductive layer, and an insulating layer sandwiched between the lower and the upper conductive layers. FIGS. 1A and 1B respectively show the layout of the lower conductive layer 204 and the upper conductive layer 208 of the touch panel according to an embodiment of the present invention.

As shown in FIG. 1A, the lower conductive layer 204 comprises a plurality of first conductive patterns 204a and a plurality of first dummy patterns 204b. The first dummy patterns 204b and the first conductive patterns 204a are electrically insulated from each other. Any two of the first dummy patterns 204b are also electrically insulated from each other. Each of the first conductive patterns 204a comprises a plurality of first electrodes 204c (the diamond portions shown in FIG. 1A) and a plurality of first bridge portions 204d (the rectangles portion shown in FIG. 1A) electrically connected to the first electrodes 204c. The first conductive patterns 204a are substantially parallel to each other and extend in a column direction for identifying the X coordinates of the touch position. The first conductive patterns 204a and the first dummy patterns 204b are patterned from a same conductive layer. In this embodiment, the materials of the first conductive patterns 204a and the first dummy patterns 204b are the same. However, in another embodiment, the first conductive patterns 204a and the first dummy patterns 204b are formed individually. In one embodiment, the material of the first conductive patterns 204a is different from that of the first dummy patterns 204b.

As shown in FIG. 1B, the upper conductive layer 208 comprises a plurality of second conductive patterns 208a and a plurality of second dummy patterns 208b. The second dummy patterns 208b and the second conductive patterns 208a are electrically insulated from each other. Any two of the second dummy patterns 208b are also electrically insulated from each other. Each of the second conductive patterns 208a comprises a plurality of second electrodes 208c (the diamond portions shown in FIG. 1B) and a plurality of second bridge portions 208d (the rectangle portions shown in FIG. 1B) electrically connected to the second electrodes 208c. The second conductive patterns 208a are substantially parallel to each other and extend in a row direction for identifying the Y coordinates of the touch position. The second conductive patterns 208a and the second dummy patterns 208b may be formed by similar methods for forming the first conductive patterns 204a and the first dummy patterns 204b.

It should be appreciated that although the extended directions of the lower conductive patterns and the upper conductive patterns shown in FIGS. 1A and 1B are substantially perpendicular to each other, the extended directions are not limited in this way and can be adjusted depending on requirements. Further, although the first electrodes 204c and the second electrodes 208c are all diamond shaped, other shapes may be used depending on requirements, such as circles, ellipses, triangles, rectangles, squares, or polygons. In addition, the shapes of the bridge portions electrically connected to the first or the second electrodes are also not limited to rectangle shapes but other shapes may be adopted instead, depending on requirements.

In this embodiment, an insulating layer is interlaid between the upper and the lower conductive layers 208 and 204 which are disposed correspondingly. That is, the electrodes of each conductive layer are disposed correspondingly to the dummy patterns of the other conductive layer. For example, the second electrodes 208c substantially overlap the corresponding first dummy patterns 204b thereunder. Also, the second dummy patterns 208b substantially overlap the corresponding first electrodes 204c.

FIG. 1C shows a top view of a portion of the layout of the upper and the lower conductive layers 208 and 204. As shown in FIG. 1C, the shapes and areas of the first electrodes 204c and the second dummy patterns 208b are substantially the same. The first electrodes 204c are substantially covered by the second dummy patterns 208b completely. The shapes and areas of the second electrodes 208c and the first dummy patterns 204b are substantially the same. The second electrodes 208c substantially cover the first dummy patterns 204b completely. FIG. 11) shows a cross-sectional view of the touch panel 200 taken along the line c1-c2-c3 of FIG. 1C. Referring to FIGS. 1A-1D, the touch panel 200 comprises a substrate 202, the lower conductive layer 204, an insulating layer 206, the upper conducive layer 208, and a protective layer 210. As shown in FIG. 1D, the lower conductive layer 204 comprises the first conductive patterns 204a (including the first electrodes 204c and the first bridge portions 204d) and the first dummy patterns 204b, wherein the First dummy patterns 204b are electrically insulated from the first conductive patterns 204a. The upper conductive layer 208 is located overlying the lower conductive layer 204 and the insulating layer 206 is interlaid therebetween. The upper conductive layer 208 comprises the second conductive patterns 208a (including the second electrodes 208c and the second bridge portions 208d) and the second dummy patterns 208b, wherein the second dummy patterns 208b are electrically insulated from the second conductive patterns 208a.

As shown in FIG. 1D, the second dummy patterns 208b are disposed on the first electrodes 204c and substantially cover the first electrodes 204c. Similarly, the first dummy patterns 204b are disposed below the second electrodes 208c and are substantially covered by the second electrodes 208c completely. Light from a region outside of the touch panel 200, such as light L1 and L2 vertically transmitted from the region below the substrate 202 will travel through the substrate 202, the lower conductive layer 204 (for light L1, through the first dummy pattern 204b; for light L2, through the first electrode 204c), the insulating layer 206, the upper conductive layer 208 (for light L1, through the second electrode 208c; for light L2, through the second dummy pattern 208b), and the protective layer 210. Thus, different lights penetrate substantially through the same medium, including a substrate, two conductive layers, an insulating layer, and a protective layer. Therefore, the display qualities between different regions of the touch panel 200 are substantially the same, further improving the entire display quality of the touch panel.

Then, with references made to FIGS. 1A-1D, the forming method of a touch panel according to an embodiment of the invention is illustrated. First, a substrate 202 is provided, such as a transparent substrate including a glass substrate, a quartz substrate, or a flexible or inflexible polymer transparent substrate. A patterned lower conductive layer 204 is then formed on the substrate 202. The lower conductive layer 204 may be, for example, a transparent conductive layer, such as an ITO layer or an IZO layer. A photolithography and etching process may be performed to pattern the transparent conductive layer into, for example, what is shown in FIG. 1A. Then, an insulating layer 206 is formed on the lower conductive layer 204. The insulating layer 206 may include a silicon oxide or a transparent insulating polymer and have a thickness ranging from between about 0.1 μm to 2 μm. A patterned upper conductive layer 208, such as that shown in FIG. 1B, is then formed on the insulating layer 206. Finally, a protective layer 210 is formed on the upper conductive layer 208 to complete the fabrication of the touch panel 200 according to an embodiment of the invention. The protective layer 210 may include a silicon oxide or a transparent insulating polymer and have a thickness ranging from between about 0.1 μm to 2 μm. In another embodiment, the touch panel 200 may further be disposed on a display panel or directly integrated into a display panel. For example, the substrate 202 may include an array substrate of a display panel.

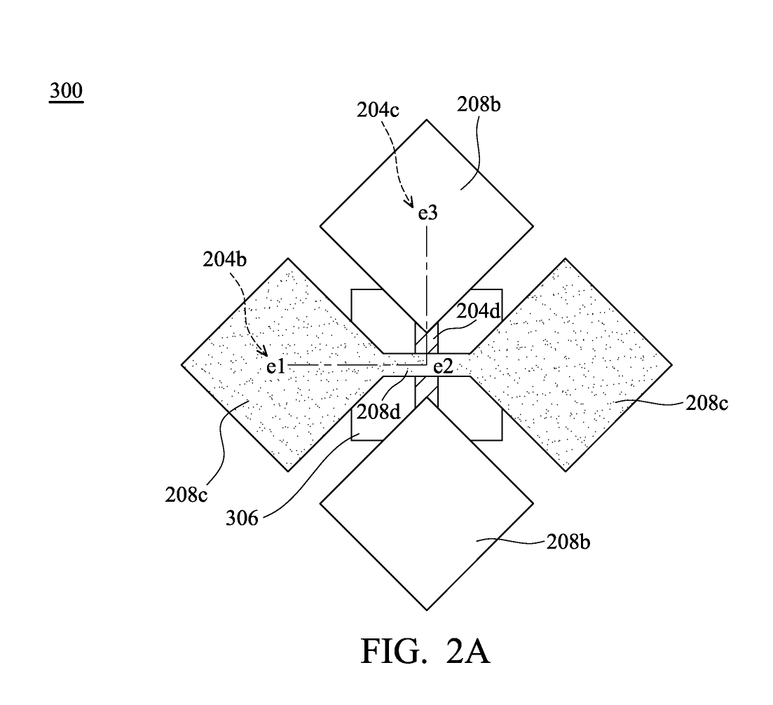

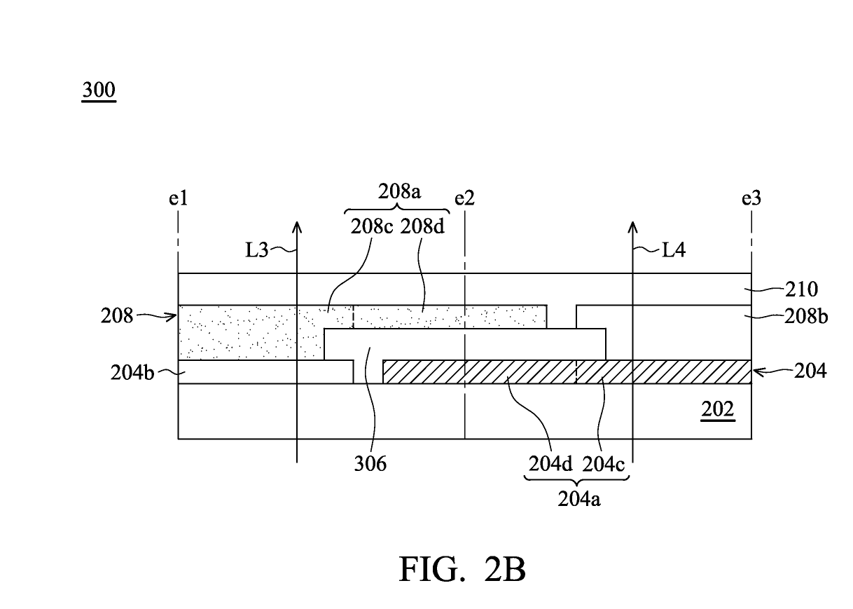

FIGS. 2A and 2B show a top view of a touch panel 300 according to another embodiment of the present invention and a cross-sectional view taken along the line e1-e2-e3 of FIG. 2A, respectively. As shown in FIG. 2A, the touch panel 300 comprises elements similar with the elements of the touch panel 200 shown in FIG. 1C. The main difference between the touch panels 300 and 200 is that the insulating layer 306 of the touch panel 300 only separate portions of the lower conductive layer 204 from the upper conductive layer 208. As shown in FIG. 2B, there is completely no or partially no insulating layer 306 disposed between the second dummy patterns 208b of the upper conductive layer 208 and the corresponding first electrodes 204c of the lower conductive layer 204. Thus, the second dummy patterns 208b directly contact with the first electrodes 204c. The insulating layer 306 is only used to separate the portions used for sensing the capacitance changes. The portions not used for sensing the capacitance changes are completely not or partially not separated by the insulating layer 306. Thus, without affecting the operation of the touch panel 300, the first electrodes 204c are further electrically connected to the second dummy patterns 208b, wherein the second dummy patterns 208b may serve as extensions of the first electrodes 204c. Therefore the electrical resistance of the electrodes may be lowered, further improving the performance of the touch panel 300. Similarly, portions or all of the first dummy patterns 204b also directly contact with the second electrodes 208c of the upper conductive layer 208. In addition, because there is partially no insulating layer 306 disposed between the lower conductive layer 204 and the upper conductive layer 208, the transmittance of the touch panel 300 may be improved.

As shown in FIG. 2B, light L3 and L4 from the region outside of the touch panel 300 may still penetrate through substantially similar mediums, thus the touch panel 300 also has better display quality.

In the embodiments shown in FIGS. 1 and 2, although the dummy patterns and the electrodes have the same shapes and areas and are disposed directly on or directly under each other, the dummy patterns may only “substantially” overlap the electrodes.

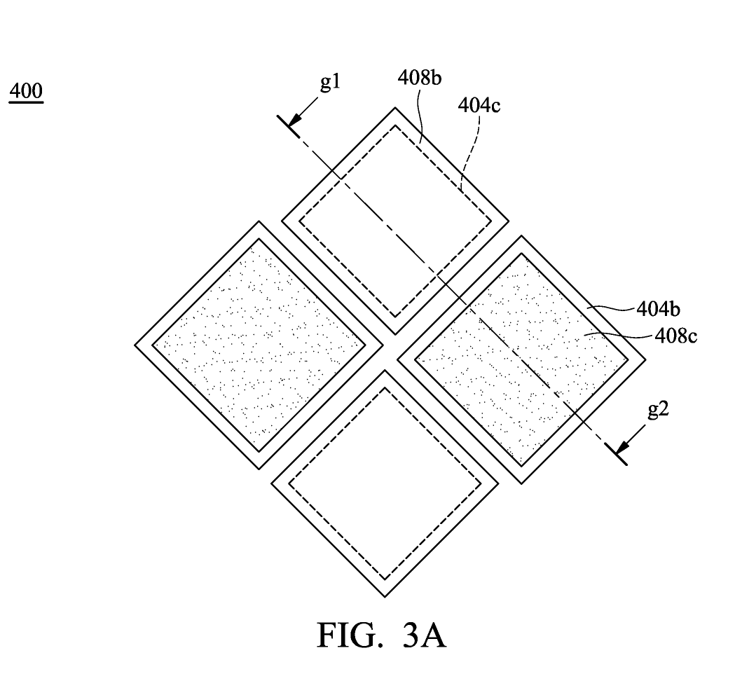

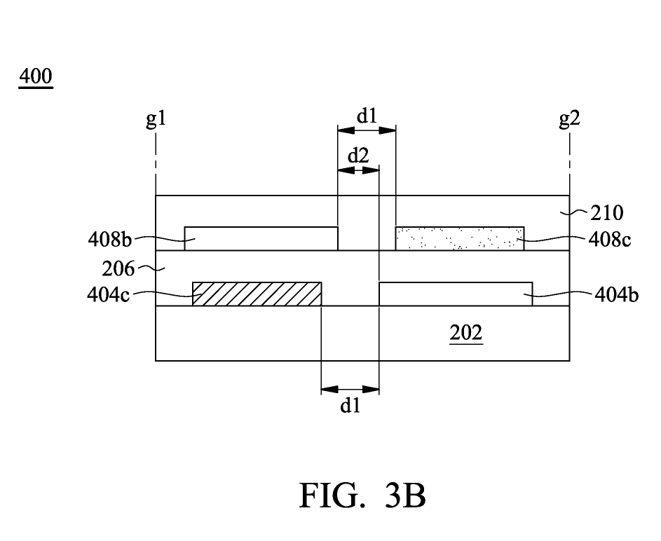

FIG. 3A shows a top view of a touch panel 400 according to another embodiment of the present invention, wherein the dummy patterns and the electrodes are staggered stacked layers. By using the staggered stacked dummy patterns and the electrodes, the lateral spacings between the sensing electrodes may be looked narrowed without disobeying process rules and affecting touch sensitivity. For clarity, the bridge portions arc not shown in FIG. 3A.

FIG. 3B shows a cross-sectional view of the touch panel 400 taken along the line g1-g2 of FIG. 3A. Limited by process rule, there is a smallest lateral distance d1 between the peripheries of the first electrodes 404c and the first dummy patterns 404b in the lower conductive layer. Also, there is a substantially equal smallest lateral distance d1 between the peripheries of the second electrodes 408c and the second dummy patterns 408b. In order to prevent the lateral distance d1 to be too wide to negatively affect the display quality of the touch panel, the lower and the upper conductive layers may be formed into a staggered stacked structure as shown in FIG. 3B through controlling of the patterning processes of the lower conductive layer and the upper conductive layer. As shown in FIGS. 3A and 3B, the peripheries of the second dummy patterns 408b extend over the peripheries of the first electrodes 404c while the peripheries of the first dummy patterns 404b extend over the peripheries of the second electrode 408c. Thus, the lateral distance d2 between the first dummy pattern 404b and the second dummy pattern 408b may be less than the distance d1. In another embodiment, the peripheries of the first electrodes 404c extend over the peripheries of the second dummy patterns 408b while the peripheries of the second electrodes 408c extend over the peripheries of the first dummy patterns 404b. Substantially without affecting the operation of the touch panel, the “looking” regions uncovered by the upper conductive layer and/or the lower conductive layer is reduced.

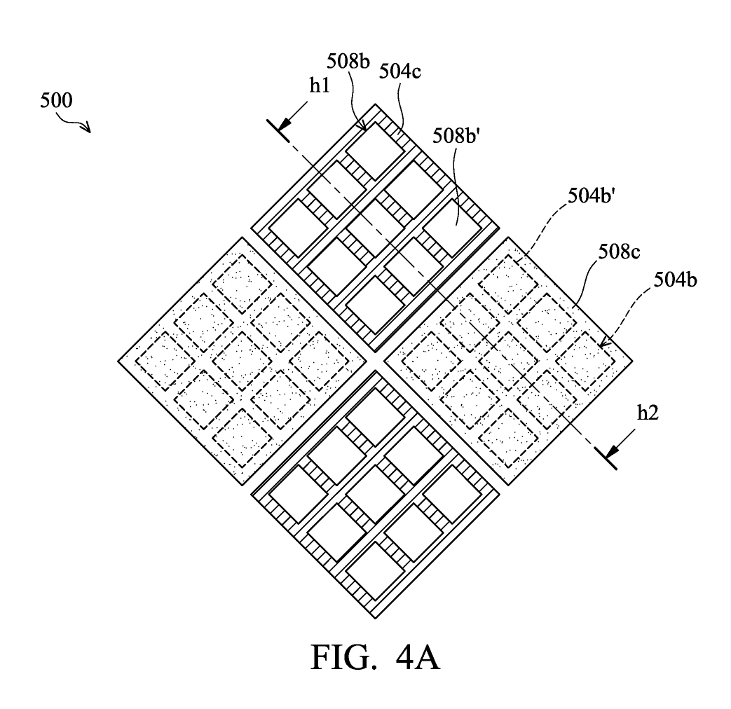

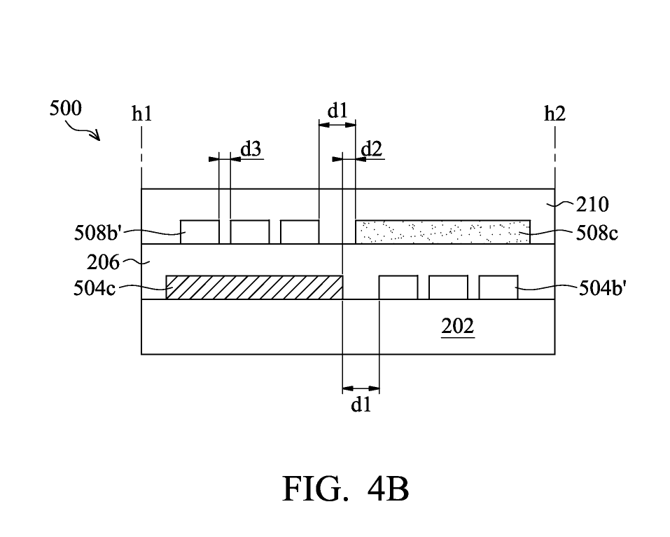

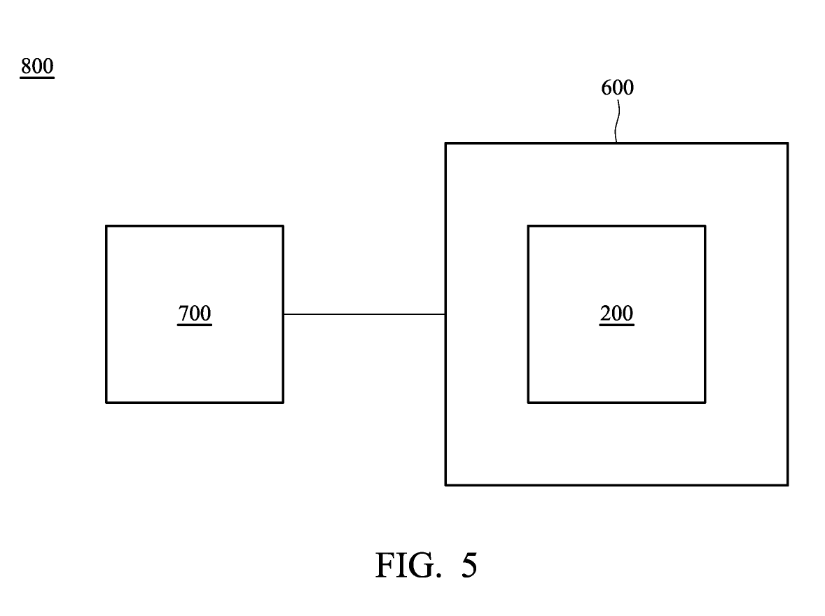

FIG. 4A shows a top view of a touch panel 500 according to another embodiment of the present invention. FIG. 4B shows a cross-sectional view of the touch panel 500 taken along the line h1-h2 of FIG. 4A. In the touch panel 500 shown in FIG. 4, at least one of the first dummy patterns 504b comprises a plurality of first sub-dummy patterns 504b′ while at least one of the second dummy patterns 508b comprises a plurality of second sub-dummy patterns 508b′. For example, the sub-dummy patterns are periodically arranged and have the same lateral spacings d3. The display quality may be more uniform by dividing the first dummy pattern 504b and the second dummy pattern 508b into a plurality of smaller first sub-dummy patterns 504b′ and second sub-dummy patterns 508b′, respectively. As shown in FIG. 4B, the staggered stacked structure as shown in FIG. 3 may also be adopted, such that the smallest lateral distance d2 between the first electrodes 504c and the second electrodes 508c may be less than the distance d1, wherein the distance d1 is a smallest lateral distance between the peripheries of the first electrodes 504c and the first sub-dummy patterns 504b′ in the lower conductive layer. In one embodiment lateral spacings d3 between the first sub-dummy patterns 504b′ (and/or the second sub-dummy patterns 508b′) substantially equal to the smallest lateral distance d2 between the first electrodes 504c and the second electrodes 508c.

FIG. 5 schematically shows a system for displaying images according to an embodiment of the present invention, which is implemented as a display device 600 or an electronic device 800, such as a mobile phone, digital camera, personal digital assistant, portable computer, personal computer, television, vehicle display, or portable DVD. In this embodiment, the display device 600 comprises the touch panel mentioned in the above embodiments, such as the touch panel 200. In addition, in another embodiment, the display device 600 may be a portion of the electronic device 800. As shown in FIG. 5, the electronic device 800 comprises the display device 600 and an input device 700. The input device 700 is coupled to the display device 600 for providing signals, for example image signals, to the display device 600 to display images.

The touch panel according to embodiments of the invention has many advantageous features. For example, the chromatic aberration problem of the conventional touch panel caused by the height difference between the upper and the lower conductive layers may be reduced. Additionally, the conductivity of the sensing electrodes may be improved. In addition, by adopting the staggered stacked layer structure and/or dividing the dummy patterns into a plurality of smaller sub-dummy patterns, the display quality of the touch panel may be improved.

While the invention has been described by way of example and in terms of the embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch panel, comprising:
a substrate;
a lower conductive layer overlaying the substrate, wherein the lower conductive layer comprises:
a plurality of first conductive patterns comprising a plurality of first electrodes; and
a plurality of first dummy patterns electrically insulated from the first conductive patterns;
an insulating layer overlaying the lower conductive layer; and
an upper conductive layer overlaying the insulating layer, wherein the upper conductive layer comprises:
a plurality of second conductive patterns comprising a plurality of second electrodes respectively overlapping the first dummy patterns; and
a plurality of second dummy patterns electrically insulated from the second conductive patterns and respectively overlapping the first electrodes.

2. The touch panel as claimed in claim 1, wherein shapes and areas of the first electrodes and the second dummy patterns are the same.

3. The touch panel as claimed in claim 1, wherein shapes and areas of the second electrodes and the first dummy patterns are the same.

4. The touch panel as claimed in claim 1, wherein the first dummy patterns are electrically connected to the second electrodes.

5. The touch panel as claimed in claim 1, wherein the second dummy patterns are electrically connected to the first electrodes.

6. The touch panel as claimed in claim 1, wherein peripheries of the second dummy patterns extend over peripheries of the first electrodes.

7. The touch panel as claimed in claim 6, wherein peripheries of the first dummy patterns extend over peripheries of the second electrodes.

8. The touch panel as claimed in claim 1, wherein peripheries of the first electrodes extend over peripheries of the second dummy patterns.

9. The touch panel as claimed in claim 8, wherein peripheries of the second electrodes extend over peripheries of the first dummy patterns.

10. The touch panel as claimed in claim 1, wherein at least one of the first dummy patterns comprises a plurality of first sub-dummy patterns.

11. The touch panel as claimed in claim 10, wherein spacings between the first sub-dummy patterns equal to a smallest lateral distance between peripheries of the second electrodes and peripheries of the first electrodes.

12. The touch panel as claimed in claim 1, wherein at least one of the second dummy patterns comprises a plurality of second sub-dummy patterns.

13. The touch panel as claimed in claim 12, wherein spacings between the second sub-dummy patterns equal to a smallest lateral distance between peripheries of the second electrodes and peripheries of the first electrodes.

14. The touch panel as claimed in claim 1, wherein at least one of the first conductive patterns further comprises a plurality of first bridge portions electrically connected to the first electrodes to term one of the first conductive patterns.

15. The touch panel as claimed in claim 1, wherein at least one of the second conductive patterns further comprises a plurality of second bridge portions electrically connected to the second electrodes to form one of the second conductive patterns.

16. The touch panel as claimed in claim 1, wherein the first conductive patterns and the first dummy patterns are portions of a same layer.

17. The touch panel as claimed in claim 1, wherein the second conductive patterns and the second dummy patterns are portions of a same layer.

18. A system for displaying images, comprising:
a display device comprising the touch panel as claimed in claim 1.

19. The system for displaying images as claimed in claim 18, further comprising:
an electronic device, wherein the electronic device comprises:
the display device; and
an input element coupled to the display device and providing a signal to the display device for displaying images.

20. The system for displaying images as claimed in claim 19, wherein the electronic device is a mobile phone, a digital camera, a personal digital assistant, a portable computer, a personal computer, a television, a vehicle display, or a portable DVD.
